(19) United States
(12) Patent Application Publication
(10) Pub. No.: US 2012/0025543 A1
(43) Pub. Date: Feb. 2, 2012

(54) Linear Hydraulic and Generator Coupling Apparatus and Method of Use Thereof

(76) Inventor: Ed Gilbert, JR., Dallas, GA (US)

(21) Appl. No.: 13/267,085

(22) Filed: Oct. 6, 2011

Related U.S. Application Data
(63) Continuation-in-part of application No. 12/709,499, filed on Mar. 8, 2010.

(51) Int. Cl. H02K 7/18; H02P 9/04; H02K 7/116; H02J 7/14; F03G 7/10

(52) U.S. Cl. 290/1 C; 310/83; 320/137; 290/7; 74/DIG. 9

(57) ABSTRACT

A linear hydraulic and generator coupling apparatus for transferring and manipulating power. The apparatus has an electrical system, a hydraulic system and a gear system. In operation, the electrical system directs the hydraulic system to force the rack of the gear system into horizontal motion. The gear system transfers the linear kinetic energy into angular momentum, and from there into electrical energy via selectively engaging alternating gears. The gear system preferably has two sets of gears that are engaged with the electrical system by selectively sliding the gears into position.

### CROSS-REFERENCE TO RELATED APPLICATIONS

The present application is a continuation-in-part application of U.S. patent application Ser. No. 12/709,499, entitled LINEAR HYDRAULIC AND GENERATOR COUPLING SYSTEM AND METHOD, filed on Mar. 8, 2010, which is incorporated herein by reference, and claims priority thereto and the full benefit thereof.

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to power transfer, and more specifically to transferring linear force into rotational force and therefrom into electricity.

2. Description of Related Art

For centuries people have utilized gears to transfer power from one form to another. Similarly, hydraulics are ubiquitous and have been for years. However, there does not exist a device that transfers and stores power as described herein.

Therefore, it is readily apparent that there is a need for a hydraulic power transferring and storing apparatus, wherein the apparatus transfers power utilizing a gear system, a hydraulic system and an electrical system.

### BRIEF SUMMARY OF THE INVENTION

Briefly described, in a preferred embodiment, the present invention overcomes the above-mentioned disadvantages and meets the recognized need for such a device by providing an apparatus for transferring and manipulating power. The apparatus has an electrical system, a hydraulic system and a gear system. The electrical system directs the hydraulic system to force the rack of the gear system into horizontal motion. The gear system transfers the linear kinetic power into rotational power, and from rotational energy into electrical power via selectively engaging gears. Preferably, the gear system has two sets of gears that are selectively engaged with the electrical system.

According to its major aspects and broadly stated, the present invention in its preferred form is a linear hydraulic and generator coupling apparatus, the linear hydraulic and generator coupling apparatus having an alternator and a gear system. The gear system has a rack and three gears, and the alternator has an intake shaft.

The first gear is cooperatively engaged with, and between, the second gear and the rack. The third gear is selectively engaged with the second gear. The rack has a third axle secured to the alternator's intake shaft, and the third gear rotates around the third axle.

The linear hydraulic and generator coupling apparatus also has a battery that is electrically connected to the alternator.

The linear hydraulic and generator coupling apparatus also has a pump and a hydraulic cylinder. The pump is electrically connected to the battery and fluidly connected to the hydraulic cylinder via a first and second tube. The hydraulic cylinder has a hydraulic shaft, which is fixedly secured to the rack.

The rack optionally has two additional gears, a fourth gear and a fifth gear. The first and fourth gear rotate around the first axle, the second gear rotates around the second axle, and the third and fifth gear rotate around the third axle. The first and fourth gears are a lower width distance apart, the third and fifth gears are an upper width distance apart. The upper width distance is less than said lower width distance. Alternatively, the upper width distance is greater than the lower width distance.

The rack also has a first track and a second track, the first track being cooperatively engaged with the first gear, and the second track being cooperatively engaged with the fourth gear.

The linear hydraulic and generator coupling apparatus also has a second battery. The alternator is electrically connected to both batteries, and the pump is electrically connected to the first battery.

The preferred embodiment further comprises a method of transferring and manipulating power comprising obtaining a linear hydraulic and generator coupling apparatus and shifting the third axle in a first axle shift direction into a first axle position, thereby engaging the fourth and fifth gears and disengaging the second and third gears.

The method also comprises sending a signal from the controller to the pump to pressurize the second tube and depressurize the first tube, thereby forcing the hydraulic shaft in the first direction.

Subsequently, the third axle is shifted in a second axle shift direction, and concurrently a signal is sent to the pump to pressurize the first tube and depressurize the second tube, thereby forcing the hydraulic shaft in a second direction.

In an alternate embodiment, the linear hydraulic and generator coupling apparatus has a first battery, an alternator, two hydro pumps, a first arm, a connecting arm, two hydro cylinders, and a second arm. The linear hydraulic and generator coupling apparatus also has transfer arms, the transfer arms being secured to both hydro cylinders. The linear hydraulic and generator coupling apparatus also has a rack with a first track, the rack being fixedly secured to the transfer arms. The linear hydraulic and generator coupling apparatus also has a first gear, the first gear being cooperatively engaged with the first track.

The linear hydraulic and generator coupling apparatus also has a first axle, the first gear rotating about the first axle, and the linear hydraulic and generator coupling apparatus also has an alternator. The alternator has an intake shaft, the intake shaft being secured to the alternator and is fixedly secured to the first axle.

The linear hydraulic and generator coupling apparatus also has a tube, the tube being fluidly connected to both hydro pumps.

More specifically, the present invention is a linear hydraulic and generator coupling apparatus, the linear hydraulic and generator coupling system having an electrical system, a hydraulic system and a gear system.

The electrical system has an alternator with an intake shaft, two batteries, input wires, output wires and a controller.

The hydraulic system comprises a pump and a hydraulic cylinder. The pump has a first tube and a second tube, and the hydraulic cylinder has a first cylinder end, a second cylinder end, and a hydraulic shaft, the hydraulic shaft having a first end and a second end.

The gear system has a rack shaft, a rack, five gears, three axles, a lower gear width and an upper gear width. The rack shaft has a first terminus, a second terminus and a middle.

The rack has a rack support, a rack width, a first track, a second track, a first direction and a second direction, the first and second tracks having a top surface and a bottom surface. Each of the five gears has a periphery and a clockwise direction of rotation. The first axle has a first set of bearings, and the second axle has a second set of bearings. The third axle has a third set of bearings, a first axle shift direction, a first axle position, a second axle shift direction and a second axle position.

The input wires conduct electricity from the alternator to the batteries. The output wires conduct electricity from the batteries to the pump and the controller.

The pump is fluidly connected to the hydraulic cylinder via the first tube and the second tube. The first tube is fixedly secured to the hydraulic cylinder near the first cylinder end, and the second tube is fixedly secured to the hydraulic cylinder near the second cylinder end.

The hydraulic shaft is secured to the hydraulic cylinder such that the first end of the hydraulic shaft is disposed near the first cylinder end of the hydraulic shaft when the hydraulic shaft is fully or mostly extended from the hydraulic cylinder. The second end of the hydraulic shaft is fixedly secured to the middle of the rack shaft, the middle preferably being halfway between the first and second termini of the rack shaft.

The first terminus of the rack shaft is fixedly secured to the first track, and the second terminus of the rack shaft is fixedly secured to the second track. The first and second tracks are a rack width distance apart. The first track and the second track are disposed in contact with a rack support, such that the bottom surface of the first track is in contact with the rack support, and the bottom surface of the second track is also in contact with the rack support. The rack support consists of ball bearings, or, alternatively, any substance, object or surface that permits the first and second tracks to move with minimal friction between the tracks and the rack support.

The top surface of the first track cooperatively engages the first gear's periphery. The first gear rotates about the first axle, and the first axle is disposed within, and rotates within, the first set of bearings. The first gear's periphery further cooperatively engages the second gear's periphery. The second gear rotates about the second axle, and the second axle is disposed within, and rotates within, the second set of bearings. The second gear's periphery selectively engages the third gear's periphery. The third gear rotates about the third axle, and the third axle is disposed within, and rotates within, the third set of bearings.

The top surface of the second track cooperatively engages the fourth gear's periphery, and the fourth gear also rotates about the first axle. The fourth gear's periphery selectively engages the fifth gear's periphery, and the fifth gear also rotates about the third axle.

In use, the controller shifts the third axle in the first axle direction until the third axle is disposed in the first axle position. In the first axle position, the second and third gear are engaged, and the fourth and fifth gear are not engaged. Subsequently, the controller commands the pump to pressurize the second tube and depressurize the first tube, thereby forcing the hydraulic shaft in the first direction.

Concurrently, the hydraulic shaft forces the rack shaft and rack to also move in the first direction. Because the top surface of the first track is cooperatively engaged with the first gear's periphery, when the first track moves in the first direction, then the first gear rotates in a clockwise direction.

Because the first gear's periphery is engaged with the second gear's periphery, when the first gear rotates in a clockwise direction, then the second gear rotates in a counter-clockwise direction. Further, as mentioned above, because the third axle is in the first axle position, the second gear's periphery is not engaged with third gear's periphery.

Concurrent to the second gear rotating counter-clockwise, because the top surface of the second track is engaged with the fourth gear's periphery, when the second track moves in the first direction, then the fourth gear rotates in a clockwise direction. In this scenario, as explained above, because the third axle is in the first axle position, the fourth gear's periphery is engaged with the fifth gear's periphery, and therefore the fifth gear and third axle rotate counter-clockwise.

Because the third axle is fixedly secured to the intake shaft, the intake shaft similarly rotates counter-clockwise. By means known in the art, the alternator utilizes the rotation of the intake shaft to generate electricity. The alternator is in electrical communication with the batteries via the output wires.

Thereafter, the controller directs the alternator to shift the third axle in a second axle direction to a second axle position. When the third axle is disposed in the second axle position then the second gear is engaged with the third gear, and the fourth gear is not engaged with the fifth gear.

Subsequently, the controller commands the pump to pressurize the first tube and depressurize the second tube, thereby forcing the hydraulic shaft in a second direction.

Concurrently, the hydraulic shaft forces the rack shaft and rack to also move in the second direction. Because the top surface of the first track is engaged with the first gear's periphery, when the first track moves in the second direction then the first gear rotates counter-clockwise.

Because the first gear's periphery is engaged with the second gear's periphery, when the first gear rotates counter-clockwise, then the second gear rotates in a clockwise direction. Because the second gear's periphery is engaged with the third gear's periphery, when the second gear rotates in a clockwise direction, then the third gear rotates counter-clockwise. Therefore, the third axle and the intake shaft similarly rotate counter-clockwise. The alternator utilized the rotation of the intake shaft to generate electricity via output wires, wherein it will be readily understood by those skilled in the art how the alternator converts the rotation of the intake shaft into electricity.

Concurrently, because the top surface of the second track is engaged with the fourth gear's periphery, when the second track moves in the second direction then the fourth gear rotates counter-clockwise. Further, and as detailed above, because the third axle is in the second axle position, the fourth gear's periphery is not engaged with the fifth gear's periphery.

Concurrent with the alternator generating electricity, the two batteries are charged by receiving electricity from the input wires.

In an alternate embodiment of a linear hydraulic and generator coupling apparatus, the linear hydraulic and generator coupling apparatus has a battery, a controller, two hydro pumps, a first arm, a pipe, a connecting arm, two hydro cylinders, a second arm, transfer arms, power wires, a first gear, a first axle, an alternator, a first linear direction and a second linear direction.

In use, the battery sends electricity to the first hydro pump via the wires. Subsequently, the first hydro pump pressurizes and forces the first arm to move in a first linear direction. Concurrently, the second hydro pump transfers excess pressure to the first hydro pump via the pipe that fluidly connects the two hydro pumps.

As the first arm moves towards the second hydro pump, the connecting arm and the second arm also move in the same direction. The second hydro cylinder transfers the movement of the second arm into the transfer arms, thereby moving the rack in the same direction.

Concurrently, because the first gear's periphery is engaged with the rack, the first gear, and the first axle, rotate counter-clockwise.

The alternator generates electricity on the input wires from the first intake shaft rotating counter-clockwise.

Subsequently, the first battery sends electricity to the second hydro pump, which then forces the first arm to move in a second linear direction. Concurrently, the first hydro pump transfers excess pressure to the second hydro pump via the pipe.

The first arm moving in the second linear direction causes the rack and first track to also move in the second linear direction, thereby forcing the first gear to rotate in a clockwise direction. The alternator thereby generates electricity on the input wires.

Accordingly, a feature and advantage of the present invention is its ability to selectively transfer linear motion into angular momentum.

Another feature and advantage of the present invention is its ability to configure the gears to only transfer a single rotational direction to the alternator.

Still another feature and advantage of the present invention is its ability to transfer multiple rotational speeds of a single rotational direction to the alternator.

Yet another feature and advantage of the present invention is its ability to utilize hydraulic advantage while converting linear motion into angular momentum.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, which are not necessarily drawn to scale, and in which like reference numerals denote similar structure and refer to like elements throughout, and in which:

FIG. 1 is a perspective view of a preferred embodiment of a linear hydraulic and generator coupling apparatus;

FIG. 2 is a detailed perspective view of the gear system of the apparatus of FIG. 1; and

FIG. 3 is a detailed view of an alternative embodiment of a linear hydraulic and generator coupling apparatus.

### DETAILED DESCRIPTION OF THE PREFERRED AND SELECTED ALTERNATE EMBODIMENTS OF THE INVENTION

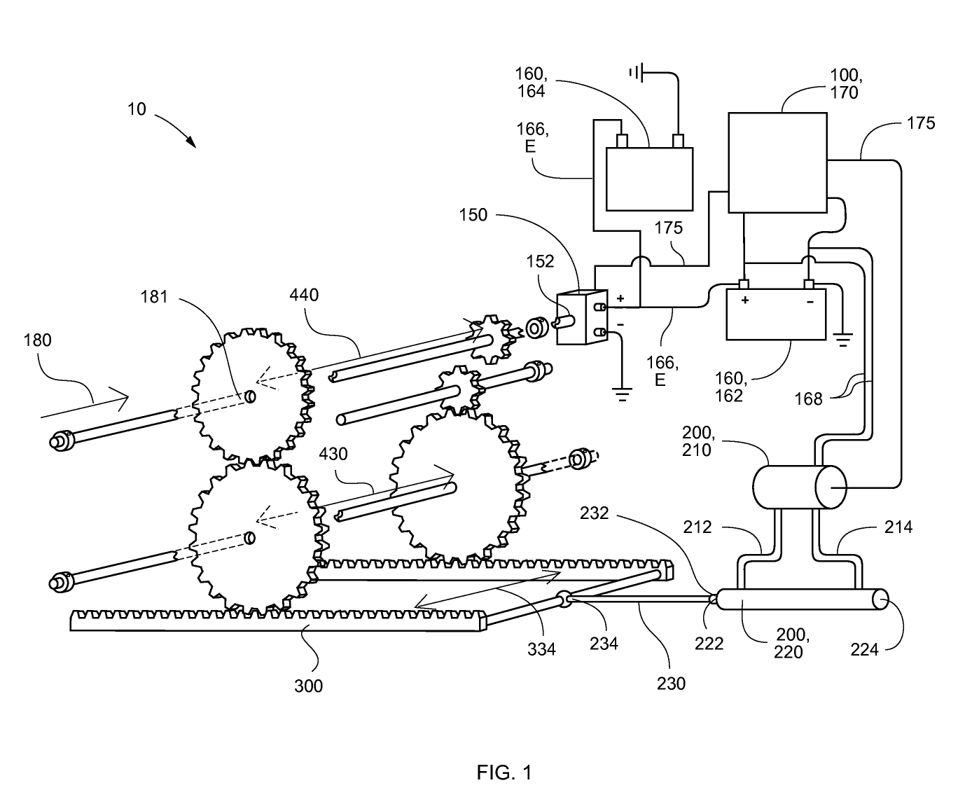

In describing the preferred and selected alternate embodiments of the present invention, as illustrated in FIGS. 1-3, specific terminology is employed for the sake of clarity. The invention, however, is not intended to be limited to the specific terminology so selected, and it is to be understood that each specific element includes all technical equivalents that operate in a similar manner to accomplish similar functions.

Referring now to FIG. 1, the present invention in a preferred embodiment comprises linear hydraulic and generator coupling apparatus 10, wherein linear hydraulic and generator coupling system 10 comprises electrical system 100, hydraulic system 200 and gear system 300. Electrical system 100 comprises alternator 150, batteries 160, input wires 166, output wires 168 and controller 170, wherein alternator 150 comprises intake shaft 152, and wherein batteries 160 comprise first battery 162 and second battery 164, and wherein controller 170 comprises control wires 175.

Hydraulic system 200 comprises pump 210 and hydraulic cylinder 220. Pump 210 comprises first tube 212 and second tube 214, and hydraulic cylinder 220 comprises first cylinder end 222, second cylinder end 224 and hydraulic shaft 230, wherein hydraulic shaft 230 comprises first end 232 and second end 234.

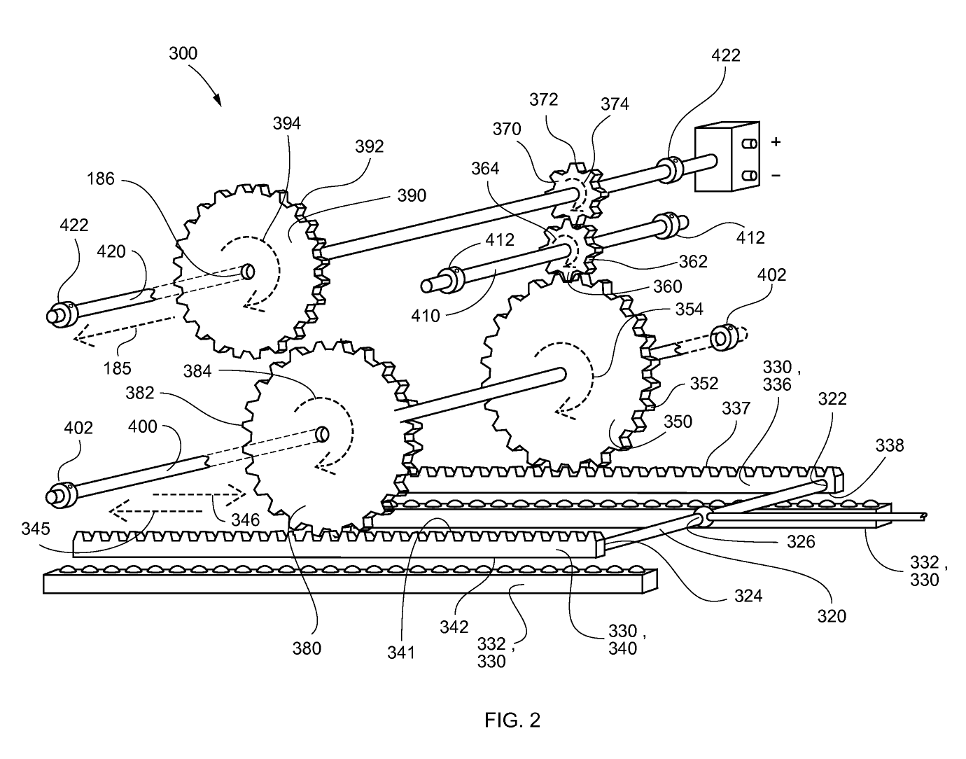

Turning now more particularly to FIGS. 1 and 2, gear system 300 comprises rack shaft 320, rack 330, first gear 350, second gear 360, third gear 370, fourth gear 380, fifth gear 390, first axle 400, second axle 410, third axle 420, lower gear width 430 (best shown in FIG. 1) and upper gear width 440 (best shown in FIG. 1). Rack shaft 320 comprises first terminus 322, second terminus 324 and middle 326.

Rack 330 comprises rack support 332, rack width 334 (best shown in FIG. 1), first track 336, second track 340, first direction 345 and second direction 346, wherein first track 336 comprises first top surface 337 and first bottom surface 338, and wherein second track 340 comprises second top surface 341 and second bottom surface 342. Rack support 332 comprises ball bearings. Alternatively, rack support 332 could comprise any substance, object or surface that permits first track 336 and second track 340 to move in first direction 345 and second direction 346 with minimal friction between rack support 332 and first track 336 and second track 340.

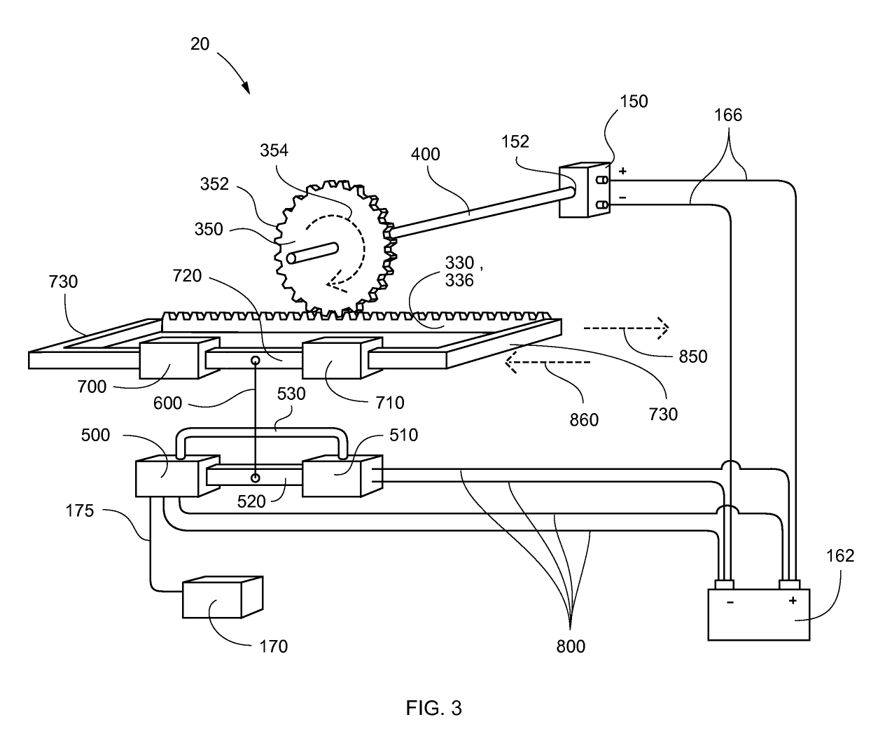

First gear 350 comprises first periphery 352 and first clockwise direction 354, second gear 360 comprises second periphery 362 and second clockwise direction 364, third gear 370 comprises third periphery 372 and third clockwise direction 374, fourth gear 380 comprises fourth periphery 382 and fourth clockwise direction 384, and fifth gear 390 comprises fifth periphery 392 and fifth clockwise direction 394. First clockwise direction 354, second clockwise direction 364, third clockwise direction 374, fourth clockwise direction 384 and fifth clockwise direction 394 are as viewed from the perspectives shown in FIGS. 1 and 3.

First axle 400 comprises first bearings 402, and second axle 410 comprises second bearings 412. Third axle 420 comprises third bearings 422, first axle shift direction 180 (best shown in FIG. 1), first axle position 181 (best shown in FIG. 1), second axle shift direction 185 and second axle position 186 (best shown in FIG. 2).

Turning back to FIG. 1, alternator 150 is in electrical communication with batteries 160 via input wires 166. Pump 210 and controller 170 are in electrical communication with batteries 160 via output wires 168. Controller 170 is in electrical communication with both pump 210 and alternator 150 via control wires 175.

Pump 210 is in fluid communication with hydraulic cylinder 220 via first tube 212 and second tube 214, wherein first tube 212 is fixedly secured to hydraulic cylinder 220 proximate to first cylinder end 222, and wherein second tube 214 is fixedly secured to hydraulic cylinder 220 proximate to second cylinder end 224.

Hydraulic shaft 230 is secured to hydraulic cylinder 220, wherein first end 232 of hydraulic shaft 230 is disposed proximate first cylinder end 222 when hydraulic shaft 230 is approximately fully extended from hydraulic cylinder 220. Second end 234 of hydraulic shaft 230 is fixedly secured to middle 326 of rack shaft 320, wherein middle 326 is preferably halfway between first terminus 322 and second terminus 324 of rack shaft 320.

First terminus 322 is fixedly secured to first track 336 of rack 330, and second terminus 324 is fixedly secured to second track 340 of rack 330, wherein first track 336 and second track 340 are rack width 334 apart. First track 336 and second track 340 are disposed in contact with rack support 332, wherein first bottom surface 338 of first track 336 is in contact with rack support 332, and wherein second bottom surface 342 of second track 340 is in contact with rack support 332.

First top surface 337 of first track 336 is cooperatively engaged with first periphery 352 of first gear 350, wherein first gear 350 rotates about first axle 400, and wherein first axle 400 is disposed within, and rotates within, first bearings 402. First periphery 352 further cooperatively engages second periphery 362 of second gear 360, wherein second gear 360 rotates about second axle 410, and wherein second axle 410 is disposed within, and rotates within, second bearings 412. Second periphery 362 selectively cooperatively engages third periphery 372 of third gear 370, wherein third gear 370 rotates about third axle 420, and wherein third axle 420 is disposed within, and rotates within, third bearings 422.

Second top surface 341 of second track 340 cooperatively engages fourth periphery 382 of fourth gear 380, wherein fourth gear 380 also rotates about first axle 400. Fourth periphery 382 selectively cooperatively engages fifth periphery 392 of fifth gear 390, wherein fifth gear 390 also rotates about third axle 420.

In use, controller 170 shifts third axle 420 in first axle direction 180, wherein third axle 420 is subsequently disposed in first axle position 181 (best shown in FIG. 1). Subsequently, controller 170 electrically communicates to pump 210 via control wire 175, and pump receives electricity E from output wires 168. Pump 210 subsequently pressurizes second tube 214 and depressurizes first tube 212, thereby forcing hydraulic shaft 230 in first direction 345.

Concurrent to hydraulic shaft 230 moving in first direction 345, hydraulic shaft 230 forces rack shaft 320 and rack 330 to also move in first direction 345, wherein rack 330 moving in first direction 345 comprises first track 336 and second track 340 moving in first direction 345. Because first top surface 337 of first track 336 is engaged with first periphery 352 of first gear 350, when first track 336 moves in first direction 345, then first gear 350 rotates in first clockwise direction 354.

Because first periphery 352 is engaged with second periphery 362 of second gear 360, when first gear 350 rotates in first clockwise direction 354, then second gear 360 rotates counter-clockwise from second clockwise direction 364. Further, because third axle 420 is in first axle position 181, second periphery 362 is disengaged from third periphery 374 of third gear 370.

Concurrently, because second top surface 341 of second track 340 is engaged with fourth periphery 382 of fourth gear 380, when second track 340 moves in first direction 345 then fourth gear 380 rotates in fourth clockwise direction 384. Because third axle 420 is in first axle position 181, fourth periphery 382 is engaged with fifth periphery 392 of fifth gear 390, and therefore fifth gear 390 and third axle 420 rotate counter-clockwise from fifth clockwise direction 394.

Because third axle 420 is fixedly secured to intake shaft 152, intake shaft 152 similarly rotates counter-clockwise from fifth clockwise direction 394. By means known in the art, alternator 150 utilizes the rotation of intake shaft 152 to generate electricity E. Via output wires 168, alternator 150 directs electricity E to batteries 160.

Subsequently, controller 170 directs alternator 150 to shift third axle 420 in second axle direction 185, wherein third axle 420 is disposed in second axle position 186 (best shown in FIG. 2). As detailed above, when third axle 420 is disposed in second axle position 186, second gear 360 engages third gear 370, and fourth gear 380 is not engaged with fifth gear 390.

Subsequently, controller 170 electrically communicates to pump 210 via control wire 175, wherein pump receives electricity E from output wires 168. Pump 210 subsequently pressurizes first tube 212 and depressurizes second tube 214, thereby moving hydraulic shaft 230 in second direction 346.

Concurrent to hydraulic shaft 230 moving in second direction 346, hydraulic shaft 230 forces rack shaft 320 and rack 300 to also move in second direction 346, wherein rack 330 movement in second direction 346 causes first track 336 and second track 340 to move in second direction 346. Because first top surface 337 of first track 336 is engaged with first periphery 352 of first gear 350, when first track 336 moves in second direction 346, first gear 350 rotates counter-clockwise from first clockwise direction 354.

Because first periphery 352 is engaged with second periphery 362 of second gear 360, when first gear 350 rotates counter-clockwise from first clockwise direction 354, second gear 360 rotates in second clockwise direction 364. When third axle 420 is in second axle position 186, second periphery 362 is cooperatively engaged with third periphery 372. Because second periphery 362 is engaged with third periphery 372 of third gear 370, when second gear 360 rotates in second clockwise direction 364, third gear 370 rotate counter-clockwise from third clockwise direction 374, and therefore third axle 420 and intake shaft 152 similarly rotate counter-clockwise from third clockwise direction 374. Alternator 150 utilizes the rotation of intake shaft 152 to generate electricity E via output wires 168, wherein it will be readily understood by those skilled in the art how alternator 150 converts rotation into electricity E.

Concurrent to third gear 370 rotating counter-clockwise from third clockwise direction 374, because second top surface 341 of second track 340 is engaged with fourth periphery 382 of fourth gear 380, when second track 340 moves in second direction 346, fourth gear 380 rotates counter-clockwise from fourth clockwise direction 384. Because third axle 420 is in second axle position 186, fourth periphery 382 is not engaged with fifth periphery 392 of fifth gear 390.

Concurrent with alternator 150 generating electricity E, batteries 160 are charged by receiving electricity E via input wires 166. In a preferred embodiment, batteries 160 comprise first battery 162 and second battery 164 (best shown on FIG. 1). Alternatively, batteries 160 may only comprise first battery 162.

Referring now more specifically to FIG. 3, illustrated therein is an alternate embodiment of linear hydraulic and generator coupling apparatus 10, wherein the alternate embodiment of FIG. 3 is substantially equivalent in form and function to that of the preferred embodiment detailed and illustrated in FIGS. 1-2 except as hereinafter specifically referenced. Specifically, the alternate embodiment of FIG. 3 comprises linear hydraulic and generator coupling apparatus 20, wherein linear hydraulic and generator coupling apparatus 20 comprises first battery 162, controller 170, first hydro pump 500, second hydro pump 510, first arm 520, pipe 530, connecting arm 600, first hydro cylinder 700, second hydro cylinder 710, second arm 720, transfer arms 730, power wires 800, first gear 350, first axle 400, alternator 150, first linear direction 850 and second linear direction 860. Controller 170 comprises control wires 175, first gear 350 comprises first periphery 352 and first clockwise rotation 354, and transfer arms 730 comprise rack 330 and first track 336. Alternator 150 comprises first intake shaft 152, and first battery 162 comprises input wires 166.

In use, first battery 162 sends electricity E to first hydro pump 500 via wires 800. Subsequently, first hydro pump 500 pressurizes and forces first arm 520 to move in first linear direction 850. Concurrent to first hydro pump 500 pressurizing, second hydro pump 510 transfers excess pressure to first hydro pump 500 via pipe 530.

Concurrent to first arm 520 moving in first lateral direction 850 towards second hydro pump 510, connecting arm 600 and second arm 720 also move in first linear direction 850. Second hydro cylinder 710 transfers the movement of second arm 720 into transfer arms 730, wherein transfer arms 730's movement in first linear direction 850 causes rack 330 and first track 336 to move in first linear direction 850.

Concurrent to first track 336 moving in first linear direction 850, because first periphery 352 of first gear 350 is engaged with first track 336, first gear 350 rotates counter-clockwise from first clockwise direction 354, wherein first gear 350 rotating counter-clockwise from first clockwise direction 354 comprises first axle 400 rotating counter-clockwise from first clockwise direction 354.

Concurrent to first axle 400 rotating counter-clockwise from first clockwise direction 354, first intake shaft 152 also rotates counter-clockwise from first clockwise direction 354, wherein alternator 150 generates electricity E on input wires 166.

Subsequently, first battery 162 sends electricity E to second hydro pump 510 via wires 800. Subsequently, second hydro pump 510 pressurizes and forces first arm 520 to move in second linear direction 860. Concurrent to second hydro pump 510 pressurizing, first hydro pump 500 transfers excess pressure to second hydro pump 510 via pipe 530.

Concurrent to first arm 520 moving in second linear direction 860, first track 336 also moves in second linear direction 860, thereby forcing first gear 350 to rotate in first clockwise direction 354. Alternator 150 thereby generates electricity E on input wires 166.

It will be recognized by those skilled in the art that gear system 300 described in the preferred embodiment of FIGS. 1 and 2, including an axle that shifts as does third axle 420, can be utilized in the alternate embodiment of FIG. 3.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A linear hydraulic and generator coupling apparatus comprising:
an alternator; and
a gear system, said gear system comprising a rack, a first gear, a second gear and a third gear.

2. The linear hydraulic and generator coupling apparatus of claim 1, wherein said first gear is cooperatively engaged with said second gear, and wherein said third gear is selectively cooperatively engaged with said second gear, and wherein said rack is cooperatively engaged with said first gear.

3. The linear hydraulic and generator coupling apparatus of claim 2, wherein said alternator comprises an intake shaft, and wherein said rack comprises a third axle, and wherein said third gear rotates around said third axle, and wherein said third axle is fixedly secured to said intake shaft.

4. The linear hydraulic and generator coupling apparatus of claim 3, said linear hydraulic and generator coupling apparatus further comprising at least one battery, wherein said alternator is electrically connected to said at least one battery.

5. The linear hydraulic and generator coupling apparatus of claim 4, said linear hydraulic and generator coupling apparatus further comprising a pump and a hydraulic cylinder, wherein said pump is electrically connected to said at least one battery, and wherein said pump comprises a first tube and a second tube, and wherein said pump is fluidly connected to said hydraulic cylinder via both said first tube and said second tube.

6. The linear hydraulic and generator coupling apparatus of claim 5, wherein said hydraulic cylinder comprises a hydraulic shaft, and wherein said hydraulic shaft is fixedly secured to said rack.

7. The linear hydraulic and generator coupling apparatus of claim 6, wherein said rack further comprises a fourth gear and a fifth gear, and wherein said fifth gear rotates around said third axle, and wherein said first gear and said fourth gear are a first distance apart, and wherein said third gear and said fifth gear are a second distance apart, and wherein said second distance is shorter than said first distance.

8. The linear hydraulic and generator coupling apparatus of claim 6, wherein said rack further comprises a fourth gear and a fifth gear, and wherein said fourth gear and said fifth gear are selectively cooperatively engaged, and wherein said fifth gear rotates around said third axle, and wherein said first gear and said fourth gear are a first distance apart, and wherein said third gear and said fifth gear are a second distance apart, and wherein said second distance is longer than said first distance.

9. The linear hydraulic and generator coupling apparatus of claim 8, wherein said rack further comprises a first track and a second track, and wherein said second track is cooperatively engaged with said fourth gear, and wherein said rack being cooperatively engaged with said first gear comprises said first track being cooperatively engaged with said first gear.

10. The linear hydraulic and generator coupling apparatus of claim 9, wherein said at least one battery comprises a first battery and a second battery, and wherein said alternator being electrically connected to said at least one battery comprises said alternator being electrically connected to said first battery and said second battery, and wherein said pump being electrically connected to said at least one battery comprises said pump being electrically connected to said first battery.

11. A method of transferring energy, said method comprising the steps of:
obtaining a linear hydraulic and generator coupling apparatus, said linear hydraulic and generator coupling apparatus comprising a gear system, wherein said gear system comprises a rack, a first gear, a second gear, a third gear, a fourth gear, and a fifth gear, and wherein said first gear is cooperatively engaged with said rack, and wherein said second gear is cooperatively engaged with said first gear, and wherein said fourth gear is cooperatively engaged with said rack, and wherein said first gear and said fourth gear are disposed a first distance apart, and wherein said fifth gear and said third gear are disposed a second distance apart, and wherein said second distance is longer than said first distance, and wherein said third gear and said fifth gear rotate about a third axle; and
shifting said third axle in a first axle shift direction, wherein said shifting cooperatively engages said fourth gear with said fifth gear, and wherein said shifting disengages said third gear from said second gear.

12. The method of transferring energy of claim 11, wherein said linear hydraulic and generator coupling apparatus further comprises an alternator, a controller, at least one battery, a pump and a hydraulic cylinder, wherein said hydraulic cylinder comprises a hydraulic shaft, and wherein said pump comprises a first tube and a second tube, and wherein said first tube and said second tube are fluidly connected to both said pump and said hydraulic cylinder, and wherein said gear system is secured to said hydraulic shaft, said method further comprising the steps of:
sending a signal from said controller to said pump, wherein said sending is subsequent to said shifting of said third axle in said first axle shift direction; and
pressurizing said second tube and depressurizing said first tube, thereby forcing said hydraulic shaft in a first direction.

13. The method of transferring energy of claim 12, said method further comprising the step of:
shifting said third axle in a second axle shift direction, wherein said shifting is subsequent to said sending said signal from said controller to said pump, and wherein said second axle shift direction is opposite from said first axle shift direction, and wherein said shifting cooperatively engages said third gear with said second gear, and wherein said shifting disengages said fifth gear from said fourth gear.

14. The method of transferring energy of claim 13, said method further comprises the steps of:
sending a signal from said controller to said pump, wherein said sending is subsequent to said shifting said third axle in said second axle shift direction; and
pressurizing said first tube and depressurizing said second tube, thereby forcing said hydraulic shaft in a second direction, wherein said second direction is opposite from said first direction.

15. A linear hydraulic and generator coupling apparatus comprising:
a first battery;
an alternator, wherein said alternator is electrically connected to said first battery;
a first hydro pump, wherein said first hydro pump is electrically connected to said first battery;
a second hydro pump, wherein said second hydro pump is electrically connected to said first battery;
a first arm, wherein said first arm is secured to both said first hydro pump and said second hydro pump;
a connecting arm, wherein said connecting arm is fixedly secured to said first arm;
a first hydro cylinder;
a second hydro cylinder; and
a second arm, wherein said connecting arm is further fixedly secured to said second arm, and wherein said second arm is secured to both said first hydro cylinder and said second hydro cylinder.

16. The linear hydraulic and generator coupling apparatus of claim 15, said linear hydraulic and generator coupling apparatus further comprising:
transfer arms, wherein said transfer arms are secured to both said first hydro cylinder and said second hydro cylinder;
a rack, wherein said rack is fixedly secured to said transfer arms, and wherein said rack comprises a first track; and
a first gear, wherein said first gear is cooperatively engaged with said first track.

17. The linear hydraulic and generator coupling apparatus of claim 16, wherein said linear hydraulic and generator coupling apparatus further comprises:
a first axle, wherein said first gear rotates about said first axle; and
an alternator, wherein said alternator comprises an intake shaft, said intake shaft being secured to said alternator, and wherein said intake shaft is fixedly secured to said first axle.

18. The linear hydraulic and generator coupling apparatus of claim 17, wherein said linear hydraulic and generator coupling apparatus further comprises:
a tube, wherein said tube is fluidly connected to both said first hydro pump and said second hydro pump.

19. The linear hydraulic and generator coupling apparatus of claim 18, wherein said alternator is electrically connected to said first battery, said linear hydraulic and generator coupling apparatus further comprising:
a controller, wherein said controller is in electrical communication with both said first hydro pump and said second hydro pump.

20. The linear hydraulic and generator coupling apparatus of claim 18, wherein said alternator is electrically connected to said first battery, said linear hydraulic and generator coupling apparatus further comprising:
a second battery, wherein said second battery is electrically connected to said alternator.
